(19) United States
(12) Patent Application Publication
(10) Pub. No.: US 2025/0070565 A1
(43) Pub. Date: Feb. 27, 2025

(54) METHOD AND SYSTEM FOR POWER GRID OPTIMIZATION CONTROL BASED ON LINEAR TIME-VARYING MODEL

(71) Applicant: TSINGHUA UNIVERSITY, Beijing (CN)

(72) Inventors: Wenchuan WU, Beijing (CN); Siyun LI, Beijing (CN); Bin WANG, Beijing (CN); Chenhui LIN, Beijing (CN); Hongbin SUN, Beijing (CN); Qinglai GUO, Beijing (CN)

(73) Assignee: TSINGHUA UNIVERSITY, Beijing (CN)

(21) Appl. No.: 18/813,090

(22) Filed: Aug. 23, 2024

(30) Foreign Application Priority Data
Aug. 25, 2023 (CN) 202311081754X

(51) Int. Cl. H02J 3/38; H02J 3/00; H02J 3/32; H02J 7/00; H02J 7/34

(52) U.S. Cl. CPC H02J 3/381; H02J 3/003; H02J 3/004; H02J 3/32; H02J 7/0048; H02J 7/345; H02J 2203/10; H02J 2203/20; H02J 2300/24

(57) ABSTRACT

A method and system for power grid optimization control based on a linear time-varying model is provided. The system model is first estimated offline using historical data combined with a piecewise linear regression method that supports a vector regression model. For online applications, a time-varying linear model prediction control framework based on a piecewise linear model coordinates the optimization control of both fast and slow regulating devices in the power grid. This approach does not require precise system model parameters, instead learning the power grid model from historical data. The method optimizes voltage distribution, reduces operating costs, and addresses issues like bad data and collinearity in the historical data, improving the voltage quality and enabling optimal operation even with incomplete models.

### FIELD OF TECHNOLOGY

The present disclosure belongs to the technical field of power system operation and control, in particular to a method and system for power grid optimization control based on linear time-varying model.

### BACKGROUND

Driven by energy and environmental issues, a proportion of clean and decentralized renewable energy in power grids is increasing day by day, and large-scale, high-penetration renewable energy generation and power grid connection has become a forefront and hot spot in an international energy and power field. Because of the large dispersion and strong fluctuation of distributed renewable energy, it has brought a series of negative effects on a voltage quality and dispatching operation of a distribution network and even a transmission network. At the same time, the distributed renewable energy is often connected to the grid through a power electronic inverter, which has flexible and high-speed regulation capabilities. Moreover, a traditional distributed power supply and energy storage device in the power grid can also provide flexible regulating capabilities for the power grid, and these regulating devices all belong to rapid regulating devices. In addition, there are slow-speed regulating devices in the power grid, such as on-load tap-changers and switch-on capacitor banks, which need to operate on relatively slow timescales. In order to efficiently optimize the fast and slow regulating devices in the power grid and improve the voltage quality of the power grid with high permeability of renewable energy, it is necessary to coordinate the voltage and power control of the power grid.

In a traditional power grid, a method based on a power grid model is often used to achieve voltage and power control, and to optimize a cost of power generation and a voltage distribution of the power grid. However, the traditional model-based optimization control method relies on accurate parameters of system model, and an ideal model of the power grid is difficult to obtain. This model-based optimization method is not capable of guaranteeing a control effect, and control instructions are often far from an optimal condition and the power grid is in a suboptimal state. In order to deal with the problem of model incompleteness of power grid, a data-driven control method has been proposed in recent years, which can use historical data of power grid to learn the system model. However, most of the existing data-driven methods consider static optimization under a single time profile, and do not consider prospective optimization combined with system prediction information, and do not consider coordination of fast and slow control devices.

### SUMMARY

In view of the above problems, the present disclosure provides a method and system for power grid optimization control based on a linear time-varying model, and coordinated optimization control is performed on a variety of fast regulating devices and slow regulating devices in the power grid, and a voltage distribution of the power grid is optimized and an operating cost is reduced.

A specific technical scheme of the present disclosure is a method for power grid optimization control based on a linear time-varying model, comprising:
establishing, for a controlled power grid, a voltage and power optimization control model based on model prediction control;
establishing a piecewise linear regression model, estimating the piecewise linear regression model offline according to historical data, and approximating a power grid model by the piecewise linear regression model;
initializing a guess value of a control sequence and a prediction sequence of a power grid load and renewable energy generation; and
performing, on a power grid, voltage and power optimization control based on the linear time-varying model according to the guess value of the control sequence and the prediction sequences of the power grid load and the renewable energy generation.

Preferably, the establishing, for a controlled power grid, a voltage and power optimization control model based on model prediction control comprises:
establishing a model of a controlled device in the power grid, wherein the model of the controlled device comprises: a photovoltaic model, an on-load tap-changer model, a switch-on capacitor bank model, a traditional distributed power supply model and an energy storage model.

Preferably, the method further comprises:
determining a rated capacity of a photovoltaic inverter at a corresponding time node by the photovoltaic model according to active power and output reactive power of photovoltaic at a time node.

Preferably, the establishing an on-load tap-changer model comprises:
establishing a set of branches equipped with on-load tap-changers in the power grid according to connected nodes and branches corresponding to the connected nodes in the power grid; and
determining gear position states of transformers at the branches and nodes by the on-load tap-changer models.

Preferably, establishing a switch-on capacitor bank model comprises:
establishing the switch-on capacitor bank model according to node indexes of the power grid and a set of nodes of a switch-on capacitor bank; and
determining a state of the switch-on capacitor bank by the switch-on capacitor bank model according to active power and output reactive power of the switch-on capacitor bank at a time node, and the number of operating capacitor units.

Preferably, the establishing a traditional distributed power supply model comprises:
establishing the traditional distributed power supply model according to node indexes of the power grid and a set of nodes of a traditional distributed power supply; and
through the traditional distributed power supply model, determining a range of active power and output reactive power of the traditional distributed power supply at a time node.

Preferably, the establishing an energy storage model comprises:
establishing the energy storage model according to a set of energy storage nodes installed in the power grid and node indexes of the power grid; and
determining a remaining battery capacity of a corresponding segment at a time node through the energy storage model.

Preferably, the method further comprises:
establishing a power grid optimization control model based on model prediction control, comprising an objective function of an optimization problem to be solved at a time node; and inputting controlled device constraints and linearized power grid model approximation constraints into the power grid optimization control model as constraint conditions.

Preferably, the objective function comprises:
a cost of purchasing power from a main power grid, a cost of abandoned power, a power generation cost of traditional distributed power supply, an operating cost of an on-load tap-changer, an operating cost of a switch-on capacitor, and a cost of voltage regulation.

Preferably, the establishing a piecewise linear regression model comprises:
dividing a data set into a plurality of clusters; and
establishing the piecewise linear regression model according to active injection power of all nodes except a root node, reactive injection power of all nodes except the root node and a square of a transformer ratio of all on-load tap-changers in the power grid.

Preferably, a square of voltage amplitudes of all nodes except the root node in the power grid and active power of a PCC node in the power grid are determined through at least one of the clusters.

Preferably, the estimating the piecewise linear regression model offline according to historical data, and approximating a power grid model by the piecewise linear regression model comprises:
initializing the piecewise linear regression model, comprising: initializing an input vector and an output vector; and giving a penalty coefficient in support vector regression, a precision parameter in the support vector regression, a target parameter of piecewise linear regression, a regularization parameter in regression, a maximum number of iterations of the piecewise linear regression, and a total number of clusters of the piecewise linear regression;
calculating an initial regression parameter of each cluster, comprising: for one cluster in the total number of clusters for the piecewise linear regression, obtaining regression parameters of the linear regression model;
calculating a cluster separation coefficient and a cluster number corresponding to the number of iterations of a cluster in the total number of clusters for the piecewise linear regression; and
updating a set of input vectors of a corresponding cluster; if a current set of input vectors of the corresponding cluster is equal to a previous set of input vectors of the corresponding cluster, selecting an identifier of iterative convergence to be equal to zero; if the current set of input vectors of the corresponding cluster is not equal to the previous set of input vectors of the corresponding cluster, selecting the identifier of iterative convergence to be equal to 1, and performing an iteration once again; and obtaining an output regression coefficient and a cluster separation coefficient.

Preferably, the initializing a guess value of a control sequence and a prediction sequence of a power grid load and renewable energy generation comprises:
initializing a control variable at each time, comprising active and reactive power output of photovoltaic, energy storage, traditional renewable energy, reactive power output of a switch-on capacitor bank, and a square of a transformer ratio of an on-load tap-changer in the power grid; and
for an initial time, initializing the guess value of the control sequence as a value of a control variable at the initial time, and the prediction sequences of the power grid load and the renewable energy generation as prediction values of the load and the renewable energy generation per unit period.

Preferably, the initializing a guess value of a control sequence and a prediction sequence of a power grid load and renewable energy generation further comprises:
defining that an initial maximum number of iterations is greater than zero, an initial iteration parameter is zero, and an iteration ending identifier variable is zero.

Preferably, the performing, on a power grid, voltage and power optimization control based on the linear time-varying model according to the guess value of the control sequence and the prediction sequences of the power grid load and the renewable energy generation comprises:
calculating a prediction input vector in a corresponding time period according to the guess value of the control sequence, the prediction sequences of the power grid load and the renewable energy generation; and
determining a corresponding cluster number according to a cluster separation coefficient in the offline estimated piecewise linear regression model; and updating a regression coefficient to be a regression coefficient corresponding to a previous cluster in the offline estimated piecewise linear regression model.

Preferably, the method further comprises:
calculating an optimal control sequence value by obtaining a value of a control variable in the power grid through a power grid optimization control model;
if an initial time is greater than or equal to 1, selecting an iteration ending identifier variable to be 1;
if the initial time is 0 and an initial iteration parameter is greater than a maximum iteration parameter, selecting an iteration ending identifier variable to be 1;
if the initial time is zero and a solved value of a control variable of a corresponding time period is equal to a guess value of the value of the control variable of the corresponding time period, selecting the iteration ending identifier variable to be 1; in addition to the above three cases, selecting the iteration ending identifier variable to be 0;
updating the guess value of the control sequence; if the iteration ending identifier variable is zero, calculating an optimal control sequence value by obtaining a value of the control variable in the power grid through the power grid optimization control model once again; and
ending the calculating until the guess value of the value of the control variable is equal to the optimal control sequence value.

Based on the same concept, the present disclosure also provides a system for power grid optimization control based on a linear time-varying model, comprising:
a first model establishment unit, which is configured to establish, for a controlled power grid, a voltage and power optimization control model based on model prediction control;
a second model establishment unit, which is configured to establish a piecewise linear regression model, estimate the piecewise linear regression model offline according to historical data, and approximate a power grid model by the piecewise linear regression model;
an initialization unit, which is configured to initialize a guess value of a control sequence and a prediction sequence of a power grid load and renewable energy generation; and
a model optimization unit, which is configured to perform, on a power grid, voltage and power optimization control based on the linear time-varying model according to the guess value of the control sequence and the prediction sequences of the power grid load and the renewable energy generation.

Based on the same concept, the present disclosure also provides an electronic device which is applied in a method for power grid optimization control based on a linear time-varying model in the present disclosure, comprising:
a processor, a communication interface, a memory and a communication bus, wherein the processor, the communication interface and the memory communicate with one another through the communication bus;
the memory is configured to store a computer program; and
the processor is configured to implement the method for power grid optimization control based on a linear time-varying model when executing the program stored in the memory.

Based on the same concept, the present disclosure also provides a computer-readable storage medium on which a computer program is stored, wherein the method for power grid optimization control based on a linear time-varying model prediction is implemented when the processor executes the computer program.

The present disclosure has the following beneficial effects:

The present disclosure proposes a method for power grid optimization control based on a linear time-varying model. Firstly, a system model is estimated offline by using historical data and combining a piecewise linear regression method supporting a vector regression model, and then in an online application, a time-varying linear model prediction control framework based on a piecewise linear model is adopted to perform coordinated optimization control on fast regulating devices and slow regulating devices in a power grid. It can be seen that according to the present disclosure, accurate system model parameters are not required, and a power grid model is learned by using historical data; and coordinated optimization control is performed on a variety of fast regulating devices and slow regulating devices in the power grid, a voltage distribution of the power grid is optimized, and an operating cost is reduced. The present disclosure also considers bad data and collinearity problems that may exist in the historical data, and has robustness to the bad data in the historical data, which can greatly improve a voltage quality of the power grid, realize an optimal operation of the system under an incomplete model scenario, and reduce the operation cost of the power grid.

Other features and advantages of the present disclosure will be described in subsequent description and, in part, will become apparent from the specification or will be known by implementation of the present disclosure. The purpose and other advantages of the present disclosure may be realized and obtained by means of structures indicated in the specification and in the attached drawings.

### BRIEF DESCRIPTION OF THE DRAWINGS

In order to more clearly illustrate the technical scheme in embodiments of the present disclosure or in the prior art, the following is a brief introduction of drawings required to be used in the description of the embodiments or the prior art. Obviously, the drawings described below are only some embodiments of the present disclosure, and for a skilled person in the art, without creative labor, other drawings are also available based on these drawings.

FIG. 1 is a flow diagram of a method for power grid optimization control based on a linear time-varying model prediction in the present disclosure;

FIG. 2 is a schematic diagram of a system for power grid optimization control based on a linear time-varying model in the present disclosure; and

FIG. 3 is a schematic diagram of an electronic device applied to the present disclosure.

### DESCRIPTION OF THE EMBODIMENTS

In order to make the purpose, technical schemes and advantages of embodiments of the present disclosure more clear, the technical schemes in the embodiments of the present disclosure will be clearly and completely explained in combination with drawings attached to the embodiments of the present disclosure. Obviously, the described embodiments are a part of the embodiments of the present disclosure, but not the whole embodiments. Based on the embodiments in the present disclosure, all other embodiments obtained by a person skilled in the art without creative labor shall fall within the protection scope of the present disclosure.

It should be noted that terms such as “first” and “second” in this application are used to distinguish similar objects and are not necessarily used to describe a particular order or precedence. It should be understood that data thus used are interchangeable where appropriate for the purposes of the embodiments of this application described herein. In this application, the term such as “up”, “down”, “left” and “right”, “before”, “after”, “top”, “bottom”, “inside”, “outside”, “in”, “vertical”, “horizontal”, “lateral” or “longitudinal” indicates an orientation or position relation based on an orientation or position shown in the appended drawings.

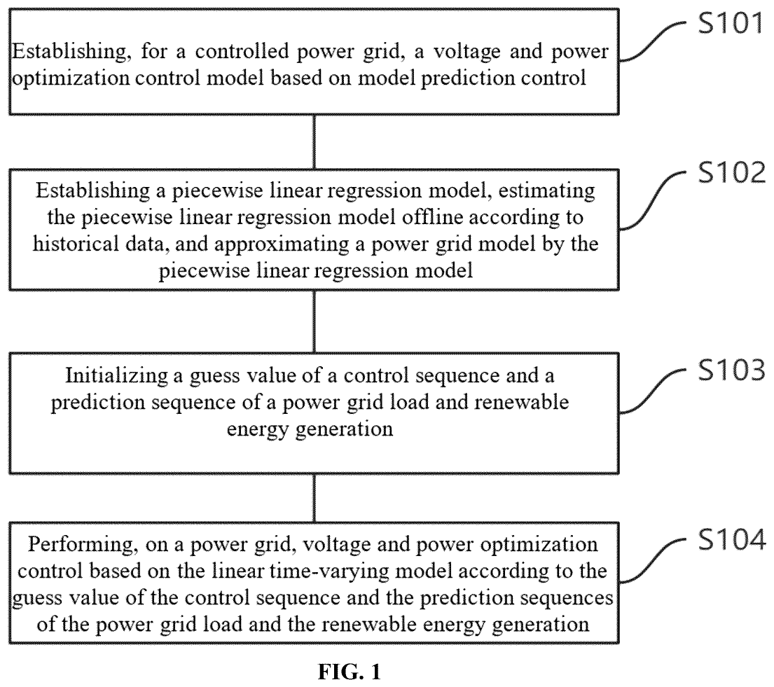

The present disclosure provides is a method for power grid optimization control based on a linear time-varying model that can be executed by a device such as a computer or a server, as shown in FIG. 1, comprising:
S101: establishing, for a controlled power grid, a voltage and power optimization control model based on model prediction control;
S102: establishing a piecewise linear regression model, estimating the piecewise linear regression model offline according to historical data, and approximating a power grid model by the piecewise linear regression model;
S103: initializing a guess value of a control sequence and a prediction sequence of a power grid load and renewable energy generation;
S104: performing, on a power grid, voltage and power optimization control based on the linear time-varying model according to the guess value of the control sequence and the prediction sequences of the power grid load and the renewable energy generation.

Specifically, the establishing, for a controlled power grid, a voltage and power optimization control model based on model prediction control comprises:
establishing a model of a controlled device in the power grid, wherein the model of the controlled device comprises: a photovoltaic model, an on-load tap-changer model, a switch-on capacitor bank model, a traditional distributed power supply model and an energy storage model;
determining a rated capacity of a photovoltaic inverter at a corresponding time node by the photovoltaic model according to active power and output reactive power of photovoltaic at a time node.

Specifically, the photovoltaic model is expressed as:

$$0 \leq {P}_{PV , i} ( {t}_{k} ) \leq {\overline{P}}_{PV , i} ( {t}_{k} ) \qquad ( 1 )$$

$${{P}_{PV , i} ( {t}_{k} )}^{2} + {{Q}_{PV , i} ( {t}_{k} )}^{2} \leq {S}_{PV , i}^{2}$$

$$∀ {t}_{k} ∈ \{ t + 1 , … , t + H \}$$

$$∀ i ∈ {N}_{PV}$$

Wherein N_{PV} represents a set of nodes installed with photovoltaic in the power grid, and i represents a node index of the power grid. P_{PV,i}(tₖ) and Q_{PV,i}(tₖ) respectively represent active power and output reactive power of photovoltaic at a node i at time tₖ, and P̅_{PV,i}(tₖ) is an upper limit of the active power of the photovoltaic at the node i at the time tₖ. S_{PV,i} is a rated capacity of the photovoltaic inverter at the node 1 at the time tₖ.

In the present disclosure, the on-load tap-changer model established in the power grid is expressed as (2):

$${Γ}_{ij} ( {t}_{k} ) = {T}_{ij , min}^{2} + {\sum }_{n = 0}^{{N}_{T}} ( 2 \cdot {α}_{ij , step} \cdot n + {α}_{ij , step}^{2} \cdot {n}^{2} ) \cdot {θ}_{Tij}^{n} ( {t}_{k} ) \qquad ( 2 )$$

$${N}_{ij} ( {t}_{k} ) = {\sum }_{n = 0}^{{N}_{T}} n \cdot {θ}_{Tij}^{n} ( {t}_{k} )$$

$${\sum }_{n = 0}^{{N}_{T}} {θ}_{Tij}^{n} ( {t}_{k} ) = 1 , {θ}_{Tij}^{n} ( {t}_{k} ) ∈ binary$$

$${θ}_{Tij}^{n} ( t + k ) - {θ}_{Tij}^{n} ( t + k - 1 ) \leq {θ}_{Tij}^{n} ( t + {γ}_{1} )$$

$${θ}_{Tij}^{n} ( t + k - 1 ) - {θ}_{Tij}^{n} ( t + k ) \leq 1 - {θ}_{Tij}^{n} ( t + {γ}_{1} )$$

$$∀ {γ}_{1} ∈ [ t + k , min ( t + k + {T}_{OLTC}^{h} - 1 , t + H ) ]$$

$$∀ k ∈ \{ 1 , 2 , … , H \}$$

$$∀ {t}_{k} ∈ \{ t + 1 , … , t + H \}$$

$$∀ ( i , j ) ∈ {E}_{T}$$

Wherein E_{T} represents a set of branches equipped with on-load tap-changers in the power grid, and (i, j) represents a branch connecting the node i to the node j in the power grid. t represents current time, tₖ, k, and γ₁ are all integer parameters representing values of time, and H is a prediction range in the model prediction control. Γᵢⱼ(tₖ) represents a square of a transformer ratio corresponding to the on-load tap-changer at the branch (i, j) at the time tₖ, and Nᵢⱼ(tₖ) is an integer variable representing a gear position of a transformer at the branch (i, j) at the time tₖ. θ_{Tij}ⁿ(tₖ) corresponds a state of the gear position of the transformer corresponding to the branch (i, j) at the time tₖ and is a variable of 0-1; θ_{Tij}ⁿ (t+k), θ_{Tij}ⁿ(t+k−1) and θ_{Tij}ⁿ(t+γ₁) respectively represents values of θ_{Tij}ⁿ(tₖ) when the time tₖ is t+k, t+k−1, and t+γ₁. T_{ij,min}² is a square of the minimum transformer ratio at the branch (i, j), α_{i,j,step} is a step size of the transformer ratio at the branch (i, j), and N_{T} is the maximum gear position of the transformer. T_{OLTC}^{h} represents the minimum time interval allowed between two adjacent operations of the transformer.
establishing a set of branches equipped with on-load tap-changers in the power grid according to connected nodes and branches corresponding to the connected nodes in the power grid; and
determining gear position states of transformers at the branches and nodes by the on-load tap-changer models.

In the present disclosure, the switch-on capacitor bank model is established, which is represented as:

$${Q}_{C , i} ( {t}_{k} ) = {B}_{i} ( {t}_{k} ) \cdot {q}_{step} \qquad ( 3 )$$

$${B}_{i} ( {t}_{k} ) = {\sum }_{n = 0}^{{N}_{C}} n \cdot {θ}_{Ci}^{n} ( {t}_{k} )$$

$${\sum }_{n = 0}^{{N}_{C}} {θ}_{Ci}^{n} ( {t}_{k} ) = 1 , {θ}_{Ci}^{n} ( {t}_{k} ) ∈ binary$$

$${θ}_{i}^{n} ( t + k ) - {θ}_{i}^{n} ( t + k - 1 ) \leq {θ}_{i}^{n} ( t + {γ}_{2} )$$

$${θ}_{i}^{n} ( t + k - 1 ) - {θ}_{i}^{n} ( t + k ) \leq 1 - {θ}_{i}^{n} ( t + {γ}_{2} )$$

$$∀ {γ}_{2} ∈ [ t + k , min ( t + k + {T}_{CB}^{h} - 1 , t + H ) ] ,$$

$$∀ k ∈ \{ 1 , 2 , … , H \}$$

$$∀ {t}_{k} ∈ \{ t + 1 , … , t + H \}$$

$$∀ i ∈ {N}_{CB}$$

Wherein N_{CB} represents a set of nodes installed with a switch-on capacitor bank in

the power grid, and i represents the node index of the power grid. t represents the current time, tₖ, k, and γ₂ are all integer parameters representing the values of time. Q_{C,i}(tₖ) and Bᵢ(tₖ) are respectively a reactive power output of the switch-on capacitor bank at the node i at the time tₖ and the number of operating capacitor units. θ_{Ci}ⁿ(tₖ) corresponds a state of the switch-on capacitor bank at the node i at the time tₖ and is variable of 0-1; θ_{Ci}ⁿ(t+k), θ_{Ci}ⁿ(t+k−1) and θ_{Ci}ⁿ(t+γ₂) respectively represents values of θ_{Ci}ⁿ(tₖ) when the time tₖ is t+k, t+k−1, and t+γ₂. N_{C} is the number of capacitor units of each switch-on capacitor bank, qₛₜₑₚ is reactive power capacity of each capacitor unit, and T_{CB}^{h} represents the minimum time interval allowed between two adjacent operations of the switch-on capacitor bank.
establishing the switch-on capacitor bank model according to node indexes of the power grid and a set of nodes of a switch-on capacitor bank; and
determining a state of the switch-on capacitor bank by the switch-on capacitor bank model according to active power and output reactive power of the switch-on capacitor bank at a time node, and the number of operating capacitor units.

In the present disclosure, the traditional distributed power supply model is established, which is represented as:

$$0 \leq {P}_{CG , i} ( {t}_{k} ) \leq {\overline{P}}_{CG , i} \qquad ( 4 )$$

$$0 \leq {Q}_{CG , i} ( {t}_{k} ) \leq {\overline{Q}}_{CG , i}$$

$$∀ {t}_{k} ∈ \{ t + 1 , … , t + H \}$$

$$∀ i ∈ {N}_{CG}$$

Wherein N_{CG} represents a set of nodes installed with a traditional distributed power supply in the power grid, and i represents the node index of the power grid. P_{CG,i}(tₖ) and Q_{CG,i}(tₖ) respectively represent active and reactive output power of the traditional distributed power supply at the node i at the time tₖ. P̅_{CG,i} and Q̅_{CG,i} respectively represent active and reactive output power of the traditional distributed power supply at the node i.
establishing the traditional distributed power supply model according to node indexes of the power grid and a set of nodes of a traditional distributed power supply; and
through the traditional distributed power supply model, determining a range of active power and output reactive power of the traditional distributed power supply at a time node.

In the present disclosure, the energy storage model is established, which is represented as:

$${e}_{i}^{l} ( {t}_{k} ) - {e}_{i}^{l} ( {t}_{k} - 1 ) = \frac{Δ t}{{E}_{i}^{rate}} ( {η}_{ch} {p}_{ch , i}^{l} ( {t}_{k} ) + \frac{{p}_{dis , i}^{l} ( {t}_{k} )}{{η}_{dis}} ) \qquad ( 5 )$$

$$0 \leq {e}_{i}^{l} ( {t}_{k} ) \leq {\overline{{e}_{i}}}^{l}$$

$${P}_{dis , i} ( {t}_{k} ) = {\sum }_{l = 1}^{L} {p}_{dis , i}^{l} ( {t}_{k} )$$

$${P}_{ch , i} ( {t}_{k} ) = {\sum }_{l = 1}^{L} {p}_{ch , i}^{l} ( {t}_{k} )$$

$${P}_{dis , i} ( {t}_{k} ) \leq {\overline{P}}_{dis , i} ( {t}_{k} ) ( 1 - {v}_{i} ( {t}_{k} ) )$$

$${P}_{ch , i} ( {t}_{k} ) \leq {\overline{P}}_{ch , i} ( {t}_{k} ) {v}_{i} ( {t}_{k} )$$

$${\underline{E}}_{i} \leq {\sum }_{l = 1}^{L} {e}_{i}^{l} ( {t}_{k} ) \leq {\overline{E}}_{i}$$

$${{P}_{dis , i} ( {t}_{k} )}^{2} + {{Q}_{ES , i} ( {t}_{k} )}^{2} \leq {S}_{ES , i}^{2}$$

$${{P}_{ch , i} ( {t}_{k} )}^{2} + {{Q}_{ES , i} ( {t}_{k} )}^{2} \leq {S}_{ES , i}^{2}$$

$$∀ {t}_{k} ∈ \{ t + 1 , … , t + H \}$$

$$∀ i ∈ {N}_{ES}$$

Wherein N_{ES} represents a set of nodes installed with energy storage in the power grid, and i represents the node index of the power grid. A cycle aging cost of the energy storage is represented by piecewise linear representation, and a cycle depth of each energy storage is divided into L parts, l represents an index of each segment, l∈{1, . . . , L}. eᵢ^{l}(tₖ) and eᵢ^{l}(tₖ−1) are respectively a remaining battery capacity corresponding to an l^{th} segment of the energy storage at the node i at the time tₖ and time tₖ−1, and ēᵢ^{l} is an upper limit of the remaining battery capacity corresponding to the l^{th} segment of the energy storage at the node i. p_{ch,i}^{l}(tₖ) and p_{dis,i}^{l}(tₖ) are respectively a charging power and a discharge power corresponding to the l^{th} segment of the energy storage at the node i at the time tₖ, and Θ_{ch} and Θ_{dis} are respectively a charging efficiency and a discharge efficiency of the energy storage. Δt is a time interval, and Eᵢ^{rate} is a rated capacity of the energy storage at the node i. P_{dis,i}(tₖ) and P_{ch,i}(tₖ) are respectively an actual discharge power and an actual charging power of the energy storage at the node i at the time tₖ, and P̅_{dis,i}(tₖ) and P̅_{ch,i}(tₖ) and are respectively upper limits of the actual discharge power and actual charging power of the energy storage at the node i at the time tₖ. vᵢ(tₖ) is a variable of 0-1 representing charging or discharging states of the energy storage at the node i at the time tₖ, and Ēᵢ and Eᵢ are respectively the maximum and minimum of the remaining battery capacity of the energy storage at the node i. Q_{ES,i}(tₖ) is a reactive power output of the energy storage at the node i at the time tₖ, and S_{ES,i} is a rated capacity of an energy storage inverter at the node i.
establishing the energy storage model according to a set of energy storage nodes installed in the power grid and node indexes of the power grid; and
determining a remaining battery capacity of a corresponding segment at a time node through the energy storage model.

In some alternative embodiments, establishing a power grid optimization control model based on model prediction control, comprising an objective function of an optimization problem to be solved at a time node; and inputting controlled device constraints and linearized power grid model approximation constraints into the power grid optimization control model as constraint,
wherein the objective function comprises:
a cost of purchasing power from a main power grid, a cost of abandoned power, a power generation cost of traditional distributed power supply, an operating cost of an on-load tap-changer, an operating cost of a switch-on capacitor, and a cost of voltage regulation.

In some alternative embodiments, the establishing a piecewise linear regression model comprises:
dividing a data set into a plurality of clusters; and
establishing the piecewise linear regression model according to active injection power of all nodes except a root node, reactive injection power of all nodes except the root node and a square of a transformer ratio of all on-load tap-changers in the power grid.

Specifically, the power grid optimization control model based on model prediction control is established as (6);

$$min {F}_{t} = {F}_{ele} + {F}_{PV} + {F}_{CG} + {F}_{OLTC} + {F}_{CB} + {F}_{ES} + {F}_{V} \qquad ( 6 )$$

$$s . t . \{ \begin{matrix}( 1 ) - ( 5 ) \\ y ( {t}_{k} ) = w ( {t}_{k} ) \cdot x ( {t}_{k} ) + b ( {t}_{k} ) , ∀ {t}_{k} ∈ \{ t + 1 , … , t + H \}\end{matrix}$$

Wherein Fₜ represents the objective function of the optimization problem to be solved at the time t, and the constraints comprise the aforementioned controlled device constraints (1) to (5) and linearized power grid model approximation constraints. w(tₖ) and b(tₖ) represent coefficients corresponding to the power grid linearization model at the time tₖ, and y(tₖ) and x(tₖ) are respectively a dependent variable and an independent variable in the power grid linearization model at the time tₖ. The objective function comprises a cost Fₑₗₑ of purchasing power from a main power grid, a cost F_{PV} of abandoned power, a power generation cost F_{CG} of traditional distributed power supply, an operating cost F_{OLTC} of on-load tap-changer, an operating cost F_{CB} of switch-on capacitor and a cost F_{V} of voltage regulation and a specific expression thereof is as follows:

$${F}_{ele} = {\sum }_{k = 1}^{H} {c}_{ele} {P}_{0} ( t + k ) \qquad ( 7 )$$

$${F}_{PV} = {\sum }_{k = 1}^{H} {\sum }_{i ∈ {N}_{PV}} {{λ}_{PV , i} ( {P}_{PV , i} ( t + k ) - {\overline{P}}_{PV , i} ( t + k ) )}^{2} \qquad ( 8 )$$

$${F}_{CG} = {\sum }_{k = 1}^{H} {\sum }_{i ∈ {N}_{CG}} {a}_{i} {P}_{CG , i}^{2} ( t + k ) + {b}_{i} {P}_{CG , i} ( t + k ) \qquad ( 9 )$$

$${F}_{OLTC} = {\sum }_{k = 1}^{H} {\sum }_{( i , j ) ∈ {E}_{T}} {{λ}_{OLTC , ij} ( {N}_{ij} ( t + k ) - {N}_{ij} ( t + k - 1 ) )}^{2} \qquad ( 10 )$$

$${F}_{CB} = {\sum }_{k = 1}^{H} {\sum }_{i ∈ {N}_{CB}} {{λ}_{CB , i} ( {B}_{i} ( t + k ) - {B}_{i} ( t + k - 1 ) )}^{2} \qquad ( 11 )$$

$${F}_{V} = {\sum }_{k = 1}^{H} {\sum }_{i ∈ N} {{λ}_{x , i} ( {U}_{i} ( t + k ) - {U}_{ref} )}^{2} \qquad ( 12 )$$

Wherein Cₑₗₑ is a price coefficient of purchasing power from the main power grid, and P₀(t+k) represents active power at a gateway node of the power grid at the time t+k, that is, a PCC node. λ_{PV,i} is a photovoltaic light abandonment penalty coefficient at the node i, P_{PV,i}(t+k) is active output power of the photovoltaic at the node i at the time t+k, and P̅_{PV,i}(t+k) is an active output power upper limit of the photovoltaic at the node i at the time t+k. aᵢ and bᵢ are power generation cost coefficients of the traditional distributed power supply at the node i, and P_{CG,i}(t+k) is the active output power of the traditional distributed power supply at the node i at the time t+k. λ_{OLTC,ij} is an operating cost coefficient of the on-load tap-changer at the branch (i, j), and Nᵢⱼ(t+k) and Nᵢⱼ(t+k−1) are respectively gear and positions of the on-load tap-changer at the branch (i, j) at time t+k and time t+k−1. λ_{CB,i} is an operating cost coefficient of the switch-on capacitor bank at the node i, and Bᵢ(t+k) and Bᵢ(t+k−1) are respectively the number of operating capacitor units of the switch-on capacitor bank at the node i at the time t+k and the time t+k−1. λ_{x,i} is a voltage deviation penalty coefficient at the node i, Uᵢ(t+k) is a square of the voltage amplitude at the node i at the time t+k, and U_{ref} is an expected distribution of a square of the voltage amplitude at the node in the power grid. N is a set of all nodes except the root node in the power grid.

The square of voltage amplitudes of all nodes except the root node in the power grid and active power of a PCC node in the power grid are determined through at least one of the clusters.

In some alternative embodiments, the estimating the piecewise linear regression model offline according to historical data, and approximating a power grid model by the piecewise linear regression model comprises:
initializing the piecewise linear regression model, comprising: initializing an input vector and an output vector; and giving a penalty coefficient in support vector regression, a precision parameter in the support vector regression, a target parameter of piecewise linear regression, a regularization parameter in regression, a maximum number of iterations of the piecewise linear regression, and a total number of clusters of the piecewise linear regression;
calculating an initial regression parameter of each cluster, comprising: for one cluster in the total number of clusters for the piecewise linear regression, obtaining regression parameters of the linear regression model;
calculating a cluster separation coefficient and a cluster number corresponding to the number of iterations of a cluster in the total number of clusters for the piecewise linear regression; and
updating a set of input vectors of a corresponding cluster; if a current set of input vectors of the corresponding cluster is equal to a previous set of input vectors of the corresponding cluster, selecting an identifier of iterative convergence to be equal to zero; if the current set of input vectors of the corresponding cluster is not equal to the previous set of input vectors of the corresponding cluster, selecting the identifier of iterative convergence to be equal to 1, and performing an iteration once again; and obtaining an output regression coefficient and a cluster separation coefficient.

Specifically, estimating the piecewise linear regression model offline according to historical data, and approximating a power grid model is detailed as follows:

S21: establishing the piecewise linear regression model. The data set is divided into a plurality of clusters, and a linear model of a k^{th} cluster is represented as follows:

$$y = {w}_{k} \cdot x + {b}_{k} \qquad ( 13 )$$

The output vector is y=[U^{T}, P₀^{T}]^{T}, U is a square of the voltage amplitude of all nodes except the root node in the power grid, and P₀ is the active power of the PCC node of the power grid. The input vector is x=[P^{T}, Q^{T}, Γ^{T}]^{T}. P is active injection power of all nodes except the root node in the power grid, Q is reactive injection power of all nodes except the root node in the power grid, and Γ is a square of the transformer ratio of all on-load tap-changers in the power grid. The superscript T in the formula represents the transpose of a vector. wₖ and bₖ represent a regression coefficient corresponding to the k^{th} cluster, k=1, . . . , K.

S22: initializing model parameters. A measurement data set is represented as {(xₙ, yₙ)|n=1, . . . , N}, wherein xₙ and yₙ are respectively an input vector and an output vector in a n^{th} data, and N is a total number of samples in the data set. It is given that a penalty parameter in support vector regression C>0, a precision parameter in the support vector regression ò>0, a target parameter of piecewise linear regression σ>0, a regularization parameter in softmax regression β>0, a maximum number of iterations of the piecewise linear regression cₘₐₓ>0 and a total number of clusters of the piecewise linear regression K>0. The number of iterations is initialized as c=0. An initial partition of the cluster for the data set is given by {Sₖ⁰}ₖ₌₁^{K}, wherein Sₖ⁰ represents a set of input vectors corresponding to the k^{th} cluster partitioned by a 0^{th} iteration. Initial regression parameter {wₖ⁰, bₖ⁰}ₖ₌₁^{K} of each cluster is calculated, wherein wₖ⁰ and bₖ⁰ are the k^{th} cluster regression coefficients calculated in the 0^{th} iteration.

S23: for ∀k=1, . . . , K, solving the following problem to obtain regression parameters wₖ^{c+1} and bₖ^{c+1},

$$( {w}_{k}^{c + 1} , {b}_{k}^{c + 1} , {ξ}_{n} , {ξ}_{n}^{*} ) = {arg min}_{( {w}_{k} , {b}_{k} , {ξ}_{n ,} {ξ}_{n}^{*} )} \frac{1}{2} {\sum }_{i = 1}^{m} {‖ {w}_{k j} ‖}^{2} + C {\sum }_{i = 1}^{m} {\sum }_{n ∈ {J}_{k}} ( {ξ}_{n , i} + {ξ}_{n , i}^{*} ) \qquad ( 14 )$$

$$s . t . {y}_{n} - {w}_{k} {x}_{n} - {b}_{k} \leq ò + {ξ}_{n}$$

$${w}_{k} {x}_{n} + {b}_{k} - {y}_{n} \leq ò + {ξ}_{n}^{*}$$

$${ξ}_{n} , {ξ}_{n}^{*} \geq 0$$

wherein wₖ^{c+1} and bₖ^{c+1} represent the regression coefficients corresponding to the k^{th} cluster calculated in a (c+1)^{th} iteration. m is a dimension of the vector yₙ, w_{k,i} represents a vector in an i^{th} row of the matrix wₖ, and Jₖ represents aset of a numbering of data points partitioned to the k^{th} cluster. ξₙ and ξ*ₙ are auxiliary vectors of m dimensions, and ξ_{n,i} and ξ*_{n,i} respectively represents an ith element of the vectors ξₙ and ξ*ₙ.

S24: calculating the cluster separation coefficients {ωₖ^{c+1}, γₖ^{c+1}}ₖ₌₁^{K} according to formula (15):

$${\{ {ω}_{k}^{c + 1} , {γ}_{k}^{c + 1} \}}_{k = 1}^{K} {arg min}_{{\{ {ω}_{k} \cdot {γ}_{k} \}}_{k = 1}^{K}} β {\sum }_{k = 1}^{K} ( {‖ {ω}_{k} ‖}^{2} + {‖ {γ}_{k} ‖}^{2} ) + {\sum }_{k = 1}^{K} {\sum }_{\{ n \vert {x}_{n} ∈ {S}_{k} \}} - log \frac{{e}^{{ω}_{k} {x}_{n} + {γ}_{k}}}{1 + {\sum }_{i = 1}^{K - 1} {e}^{{ω}_{i} {x}_{n} + {γ}_{i}}} \qquad ( 15 )$$

wherein ωₖ^{c+1} and γₖ^{c+1} represent the cluster separation coefficients corresponding to the k^{th} cluster calculated in a (c+1)^{th} iteration. ωₖ and γₖ represent the cluster separation coefficients corresponding to the k^{th} cluster, and ωᵢ and γᵢ represent the cluster separation coefficients corresponding to the k^{th} cluster. Sₖ represents a set of input vectors corresponding to the k^{th} cluster. e is a constant of nature.

S25: for ∀n=1, . . . , N, calculating a cluster number jₙ^{c+1} according to formula (16):

$${j}_{n}^{c + 1} = {arg min}_{j = 1 , … , K} C {\sum }_{i = 1}^{m} {\sum }_{n ∈ {J}_{k}} max \{ 0 , \vert {w}_{k , i} {x}_{n} + {b}_{k , i} - {y}_{n , i} \vert - ò \} + σ ( - log \frac{{e}^{{ω}_{k} {x}_{n} + {γ}_{k}}}{1 + {\sum }_{i = 1}^{K - 1} {e}^{{ω}_{i} {x}_{n} + {γ}_{i}}} ) \qquad ( 16 )$$

wherein jₙ^{c+1} represents a cluster number corresponding to the n^{th} data calculated in the (c+1)^{th} iteration. b_{k,i} and y_{n,i} respectively represent i^{th} elements of vectors bₖ and yₙ.

S26: updating a set of input vectors Sₖ^{c+1}, k=1, . . . , K corresponding to the k^{th} cluster calculated in the (c+1)^{th} iteration. For ∀n=1, . . . , N, xₙ is assigned to the cluster Sₖ^{c+1}, wherein k=jₙ^{c+1}.

S27: if Sₖ^{c+1}=Sₖ^{c}, ∀k∈{1, . . . , K} then flag=0; and otherwise, c=c+1, flag=1, wherein Sₖ^{c} represents the set of input vectors corresponding to the k^{th} cluster calculated in the c^{th} iteration, and flag is an iteration convergence identifier variable.

S28: determining whether the iteration is terminated. If flag=0 or c>cₘₐₓ, the iteration is terminated and step S29) is continued; and otherwise, returning to step S23).

S29: outputting a regression coefficient {wₖ, bₖ}ₖ₌₁^{K}={wₖ^{c+1}, bₖ^{c+1}, }ₖ₌₁^{K} and a cluster separation coefficient {ωₖ, γₖ}ₖ₌₁^{K}={ωₖ^{c+1}, γₖ^{c+1}}ₖ₌₁^{K}.

In some alternative embodiments, the initializing a guess value of a control sequence and a prediction sequence of a power grid load and renewable energy generation comprises:
initializing a control variable at each time, comprising active and reactive power output of photovoltaic, energy storage, traditional renewable energy, reactive power output of a switch-on capacitor bank, and a square of a transformer ratio of an on-load tap-changer in the power grid; and
for an initial time, initializing the guess value of the control sequence as a value of a control variable at the initial time, and the prediction sequences of the power grid load and the renewable energy generation as prediction values of the load and the renewable energy generation per unit period.

Specifically, a guess value of a control sequence corresponding to the time t is represented as Uₜ⁰={ũ(t+1), . . . , ũ(t+H)}, and a prediction sequence of a power grid load and as renewable energy generation corresponding to the time t is represented Mₜ={μ(t+1), . . . , μ(t+H)}. ũ(t+1), . . . , ũ(t+H) represent guess values of values of the control variable from the time t+1 to the time t+H. A control variable at each time comprises active and reactive power output of photovoltaic, energy storage, traditional renewable energy, reactive power output of a switch-on capacitor bank, and a square of a transformer ratio of an on-load tap-changer in the power grid. μ(t+1), . . . , μ(t+H) are prediction values of the load and renewable energy generation from time t+1 to t+H. For initial time t=0, the guess value Uₜ⁰={ũ(t+1), . . . , ũ(t+H)} of the control sequence is initialized as the value of the control variable at the initial time, and Mₜ={μ(t+1), . . . , μ(t+H)} is initialized as the prediction value of the load and renewable energy generation from time t+1 to t+H.

In the present disclosure, the initializing a guess value of a control sequence and a prediction sequence of a power grid load and renewable energy generation further comprises:
defining that an initial maximum number of iterations is greater than zero, an initial iteration parameter is zero, and an iteration ending identifier variable is zero. That is, it is defined that the initial maximum number of iterations is Nₘₐₓ>0, the initial iteration parameter is Nᵢₙᵢₜ=0, and the iteration ending identifier variable is ƒ_{end}=0.

In some alternative embodiments, the performing, on a power grid, voltage and power optimization control based on the linear time-varying model according to the guess value of the control sequence and the prediction sequences of the power grid load and the renewable energy generation comprises:
calculating a prediction input vector in a corresponding time period according to the guess value of the control sequence, the prediction sequences of the power grid load and the renewable energy generation; and
determining a corresponding cluster number according to a cluster separation coefficient in the offline estimated piecewise linear regression model; and updating a regression coefficient to be a regression coefficient corresponding to a previous cluster in the offline estimated piecewise linear regression model.

In some alternative embodiments, the method further comprises:
calculating an optimal control sequence value by obtaining a value of a control variable in the power grid through a power grid optimization control model;
if an initial time is greater than or equal to 1, selecting an iteration ending identifier variable to be 1;
if the initial time is 0 and an initial iteration parameter is greater than a maximum iteration parameter, selecting an iteration ending identifier variable to be 1;
if the initial time is zero and a solved value of a control variable of a corresponding time period is equal to a guess value of the value of the control variable of the corresponding time period, selecting the iteration ending identifier variable to be 1; in addition to the above three cases, selecting the iteration ending identifier variable to be 0;
updating the guess value of the control sequence; if the iteration ending identifier variable is zero, calculating an optimal control sequence value by obtaining a value of the control variable in the power grid through the power grid optimization control model once again; and
ending the calculating until the guess value of the value of the control variable is equal to the optimal control sequence value.

It should be noted that for the online optimization control of the power grid based on model prediction control, the power grid performs the following steps at time t≥0:

S41: calculating prediction input vectors x(tₖ) corresponding to the time t+1 to the time t+H according to the guess value Uₜ⁰={ũ(t+1), . . . , ũ(t+H)} of the control sequence, the prediction sequence Mₜ={μ(t+1), . . . , μ(t+H)} of power grid load and renewable energy generation, ∀tₖ=t+1, . . . , t+H.

S42: calculating a cluster number corresponding to x(tₖ), ∀tₖ=t+1, . . . , t+H according to the following formula:

$$j ( x ( {t}_{k} ) ) = {arg max}_{k = 1 , … , K} \{ {ω}_{k} \cdot x ( {t}_{k} ) + {γ}_{k} \} \qquad ( 17 )$$

wherein j(x(tₖ)) represents a cluster number corresponding to x(tₖ). ωₖ and γₖ represent the cluster separation coefficient in the offline estimated piecewise linear regression model.

S43: updating the regression coefficients to be w(tₖ)=wⱼ₍ₓ₍ₜ_{ₖ}₎₎, b(tₖ)=bⱼ₍ₓ₍ₜ_{ₖ}₎₎. wⱼ₍ₓ₍ₜ_{ₖ}₎₎ and bⱼ₍ₓ₍ₜ_{ₖ}₎₎ represent the regression coefficients corresponding to the j(x(tₖ))th cluster in the offline estimated piecewise linear regression model.

S44: solving the following optimization problem to obtain the values of the control variable in the power grid.

$$min {F}_{t} = {F}_{ele} + {F}_{PV} + {F}_{CG} + {F}_{OLTC} + {F}_{CB} + {F}_{ES} + {F}_{V} \qquad ( 6 )$$

$$s . t . \{ \begin{matrix}( 1 ) - ( 5 ) \\ y ( {t}_{k} ) = w ( {t}_{k} ) \cdot x ( {t}_{k} ) + b ( {t}_{k} ) , ∀ {t}_{k} ∈ \{ t + 1 , … , t + H \}\end{matrix}$$

The optimal control sequence solved is represented as U*ₜ{u*(t+1), . . . , u*(t+H)}, wherein u*(t+1), . . . , u*(t+H) represent the values of the solved optimal control variable corresponding to the time t+1 to the time t+H.

S45: if t≥1, then ƒ_{end}=1; If t=0 and Nᵢₙᵢₜ>Nₘₐₓ, then ƒ_{end}=1; If t=0 and u*(t+k)=ũ(t+k), ∀1≤k≤H, then ƒ_{end}=1; and otherwise, ƒ_{end}=0.

S46: updating the guess values of the control sequence. For 1≤k≤H, ũ(t+k)=u*(t+k) is given. And ũ(t+H+1)=u*(t+H) is given. ũ(t+k) and ũ(t+H+1) respectively represent guess values of values of the control variable at the time t+k and the time t+H+1.

S47: if ƒ_{end}=0, returning to step S41; and otherwise, continuing with the following step.

S48: executing a control instruction u(t+1)=u*(t+1), wherein u(t+1) represents the control variable at the time t+1 of actual execution.

t=t+1 is given, and then steps S41 to S48 are returned to.

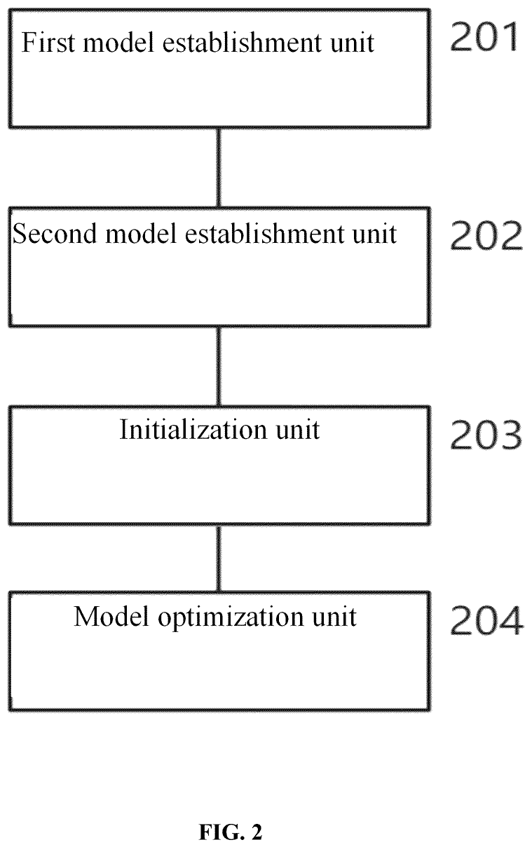

Based on the same concept, the present disclosure also provides a system for power grid optimization control based on a linear time-varying model, as shown in FIG. 2, comprising:
a first model establishment unit, which is configured to establish, for a controlled power grid, a voltage and power optimization control model based on model prediction control;
a second model establishment unit, which is configured to establish a piecewise linear regression model, estimate the piecewise linear regression model offline according to historical data, and approximate a power grid model by the piecewise linear regression model;
an initialization unit, which is configured to initialize a guess value of a control sequence and a prediction sequence of a power grid load and renewable energy generation; and
a model optimization unit, which is configured to perform, on a power grid, voltage and power optimization control based on the linear time-varying model according to the guess value of the control sequence and the prediction sequences of the power grid load and the renewable energy generation.

The present disclosure greatly improves the efficiency, safety and flexibility of the power grid voltage and power control method in the scenario of incomplete model, and is especially suitable for the power grid with a serious problem of incomplete model, which not only saves the high cost caused by repeated maintenance of the accurate model, but also realizes the prospective optimization of the future state prediction of the system through the model prediction control framework. It can optimize power grid operation in the case of distributed power supply and load fluctuations, and has robustness to bad data in the historical data, which is suitable for large-scale promotion.

The present disclosure adopts the piecewise linear regression method based on the supported vector regression model to learn the power grid model from the historical data without relying on the exact model parameters of the power grid, and can realize the optimal operation of the power grid under the scenario of incomplete model, and is robust to the bad data that may occur in the historical data.

Based on the time-varying linear model prediction control framework, the present disclosure predicts the future state change of the power grid in the optimization process, and can better coordinate the fast regulating and control devices and slow regulating and control devices in the power grid under the condition of renewable energy and load fluctuations, and reduce the operation cost of the power grid.

By adopting the linearized model, the calculation cost is reduced, high-speed flexible resources can be efficiently utilized, and the efficiency of power grid optimization control is improved.

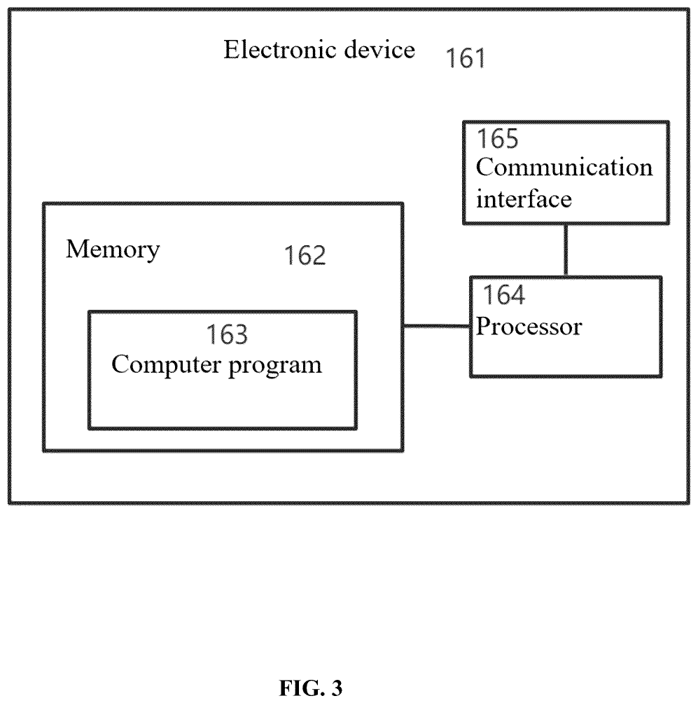

Based on the same concept, the present disclosure also provides an electronic device 161 such as a computer or a server, as shown in FIG. 3, which comprises a processor 164, a communication interface 165, a memory 162 and a communication bus, wherein the processor 164, the communication interface 165 and the memory 162 communicate with one another through the communication bus.

The memory 162 is configured to store a computer program 163.

The processor 164 is configured to implement the abovementioned method for power grid optimization control based on a linear time-varying model prediction in the present disclosure when executing the program stored in the memory 162.

The above communication bus can be a Peripheral Component Interconnect (PCI) bus or an Extended Industry Standard Architecture (EISA) bus, etc. The communication bus can be divided into an address bus, a data bus and a control bus, etc.

The communication interface 165 is configured to communicate between the electronic device 161 and other devices.

The memory 162 may comprise a Random Access Memory (RAM) 162 or a non-volatile memory 162, such as at least one disk memory 162. Optionally, the memory 162 may also be at least one storage device located away from the aforementioned processor 164.

The processor 164 may be a general purpose processor 164, including a Central Processing Unit 164 (CPU), a Network Processor 164 (NP), etc. It may also be a Digital Signal Processing 164 (DSP), an Application Specific Integrated Circuit (ASIC), a Field-Programmable Gate Array (FPGA) or other programmable logic devices, discrete gate or transistor logic devices, or discrete hardware components.

Based on the same concept, the present disclosure also provides a computer-readable storage medium on which a computer program 163 is stored, wherein the method for power grid optimization control based on a linear time-varying model prediction is implemented when the processor 164 executes the computer program 163.

The computer-readable storage medium may be comprised in the device/apparatus described in the above embodiments. It can also exist on its own and not be incorporated into the device/apparatus. The computer-readable storage medium carries one or more programs, and when the one or more programs are executed, the method for power grid optimization control based on a linear time-varying model prediction according to the disclosed embodiment is implemented.

The above embodiments are used only to illustrate the technical schemes of this application and not to restrict them. Notwithstanding the detailed description of the present application is given by reference to the foregoing embodiments, it should be understood by a person skilled in the art that he/she may modify the technical schemes recorded in the foregoing embodiments or make equivalent substitutions for some of the technical features therein. Such modifications or substitutions shall not remove the essence of the respective technical scheme from the spirit and scope of the technical scheme in each embodiment of this application.

What is claimed is:

1. A method for power grid optimization control based on a linear time-varying model, comprising:
establishing, for a controlled power grid, a voltage and power optimization control model based on model prediction control;
establishing a piecewise linear regression model, estimating the piecewise linear regression model offline according to historical data, and approximating a power grid model by the piecewise linear regression model;
initializing a guess value of a control sequence and a prediction sequence of a power grid load and renewable energy generation; and
performing, on a power grid, voltage and power optimization control based on the linear time-varying model according to the guess value of the control sequence and the prediction sequences of the power grid load and the renewable energy generation.

2. The method according to claim 1, wherein the establishing, for a controlled power grid, a voltage and power optimization control model based on model prediction control comprises:
establishing a model of a controlled device in the power grid, wherein the model of the controlled device comprises: a photovoltaic model, an on-load tap-changer model, a switch-on capacitor bank model, a traditional distributed power supply model and an energy storage model.

3. The method according to claim 2, comprising:
determining a rated capacity of a photovoltaic inverter at a corresponding time node by the photovoltaic model according to active power and output reactive power of photovoltaic at a time node.

4. The method according to claim 2, wherein the establishing an on-load tap-changer model comprises:
establishing a set of branches equipped with on-load tap-changers in the power grid according to connected nodes and branches corresponding to the connected nodes in the power grid; and
determining gear position states of transformers at the branches and nodes by the on-load tap-changer models.

5. The method according to claim 2, wherein establishing a switch-on capacitor bank model comprises:
establishing the switch-on capacitor bank model according to node indexes of the power grid and a set of nodes of a switch-on capacitor bank; and
determining a state of the switch-on capacitor bank by the switch-on capacitor bank model according to active power and output reactive power of the switch-on capacitor bank at a time node, and the number of operating capacitor units.

6. The method according to claim 2, wherein the establishing a traditional distributed power supply model comprises:
establishing the traditional distributed power supply model according to node indexes of the power grid and a set of nodes of a traditional distributed power supply; and
through the traditional distributed power supply model, determining a range of active power and output reactive power of the traditional distributed power supply at a time node.

7. The method according to claim 2, wherein the establishing an energy storage model comprises:
establishing the energy storage model according to a set of energy storage nodes installed in the power grid and node indexes of the power grid; and
determining a remaining battery capacity of a corresponding segment at a time node through the energy storage model.

8. The method according to claim 1, further comprising:
establishing a power grid optimization control model based on model prediction control, comprising an objective function of an optimization problem to be solved at a time node;
and inputting controlled device constraints and linearized power grid model approximation constraints into the power grid optimization control model as constraint conditions.

9. The method according to claim 8, wherein the objective function comprises:
a cost of purchasing power from a main power grid, a cost of abandoned power, a power generation cost of traditional distributed power supply, an operating cost of an on-load tap-changer, an operating cost of a switch-on capacitor, and a cost of voltage regulation.

10. The method according to claim 1, wherein the establishing a piecewise linear regression model comprises:
dividing a data set into a plurality of clusters; and
establishing the piecewise linear regression model according to active injection power of all nodes except a root node, reactive injection power of all nodes except the root node and a square of a transformer ratio of all on-load tap-changers in the power grid.

11. The method according to claim 10, wherein a square of voltage amplitudes of all nodes except the root node in the power grid and active power of a PCC node in the power grid are determined through at least one of the clusters.

12. The method according to claim 1, wherein the estimating the piecewise linear regression model offline according to historical data, and approximating a power grid model by the piecewise linear regression model comprises:
initializing the piecewise linear regression model, comprising: initializing an input vector and an output vector; and giving a penalty coefficient in support vector regression, a precision parameter in the support vector regression, a target parameter of piecewise linear regression, a regularization parameter in regression, a maximum number of iterations of the piecewise linear regression, and a total number of clusters of the piecewise linear regression; calculating an initial regression parameter of each cluster, comprising: for one cluster in the total number of clusters for the piecewise linear regression, obtaining regression parameters of the linear regression model;
calculating a cluster separation coefficient and a cluster number corresponding to the number of iterations of a cluster in the total number of clusters for the piecewise linear regression; and
updating a set of input vectors of a corresponding cluster; if a current set of input vectors of the corresponding cluster is equal to a previous set of input vectors of the corresponding cluster, selecting an identifier of iterative convergence to be equal to zero; if the current set of input vectors of the corresponding cluster is not equal to the previous set of input vectors of the corresponding cluster, selecting the identifier of iterative convergence to be equal to 1, and performing an iteration once again; and obtaining an output regression coefficient and a cluster separation coefficient.

13. The method according to claim 1, wherein the initializing a guess value of a control sequence and a prediction sequence of a power grid load and renewable energy generation comprises:
initializing a control variable at each time, comprising active and reactive power output of photovoltaic, energy storage, traditional renewable energy, reactive power output of a switch-on capacitor bank, and a square of a transformer ratio of an on-load tap-changer in the power grid; and
for an initial time, initializing the guess value of the control sequence as a value of a control variable at the initial time, and the prediction sequences of the power grid load and the renewable energy generation as prediction values of the load and the renewable energy generation per unit period.

14. The method according to claim 13, wherein the initializing a guess value of a control sequence and a prediction sequence of a power grid load and renewable energy generation further comprises:
defining that an initial maximum number of iterations is greater than zero, an initial iteration parameter is zero, and an iteration ending identifier variable is zero.

15. The method according to claim 1, wherein the performing, on a power grid, voltage and power optimization control based on the linear time-varying model according to the guess value of the control sequence and the prediction sequences of the power grid load and the renewable energy generation comprises:
calculating a prediction input vector in a corresponding time period according to the guess value of the control sequence, the prediction sequences of the power grid load and the renewable energy generation; and
determining a corresponding cluster number according to a cluster separation coefficient in the offline estimated piecewise linear regression model; and updating a regression coefficient to be a regression coefficient corresponding to a previous cluster in the offline estimated piecewise linear regression model.

16. The method according to claim 15, further comprising:
calculating an optimal control sequence value by obtaining a value of a control variable in the power grid through a power grid optimization control model;
if an initial time is greater than or equal to 1, selecting an iteration ending identifier variable to be 1;
if the initial time is 0 and an initial iteration parameter is greater than a maximum iteration parameter, selecting an iteration ending identifier variable to be 1;
if the initial time is zero and a solved value of a control variable of a corresponding time period is equal to a guess value of the value of the control variable of the corresponding time period, selecting the iteration ending identifier variable to be 1; in addition to the above three cases, selecting the iteration ending identifier variable to be 0;
updating the guess value of the control sequence; if the iteration ending identifier variable is zero, calculating an optimal control sequence value by obtaining a value of the control variable in the power grid through the power grid optimization control model once again; and
ending the calculating until the guess value of the value of the control variable is equal to the optimal control sequence value.

17. A system for power grid optimization control based on a linear time-varying model, comprising:
a first model establishment unit, which is configured to establish, for a controlled power grid, a voltage and power optimization control model based on model prediction control;
a second model establishment unit, which is configured to establish a piecewise linear regression model, estimate the piecewise linear regression model offline according to historical data, and approximate a power grid model by the piecewise linear regression model;
an initialization unit, which is configured to initialize a guess value of a control sequence and a prediction sequence of a power grid load and renewable energy generation; and
a model optimization unit, which is configured to perform, on a power grid, power grid optimization control based on the linear time-varying model according to the guess value of the control sequence and the prediction sequences of the power grid load and the renewable energy generation.

18. An electronic device, comprising:
a processor, a communication interface, a memory and a communication bus, wherein the processor, the communication interface and the memory communicate with one another through the communication bus;
the memory is configured to store a computer program; and
the processor is configured to implement the method for power grid optimization control based on the linear time-varying model according to claim 1 when executing the program stored in the memory.

19. (canceled)
